(19) United States
(12) Patent Application Publication
(10) Pub. No.: US 2022/0214714 A1
(43) Pub. Date: Jul. 7, 2022

(54) Digital Wall Calendar Apparatus

(71) Applicant: Michael Garcia, Fresno, CA (US)

(72) Inventor: Michael Garcia, Fresno, CA (US)

(21) Appl. No.: 17/143,507

(22) Filed: Jan. 7, 2021

(51) Int. Cl. G06F 1/16; G06Q 10/10

(52) U.S. Cl. CPC G06F 1/1605; G06Q 10/1093; G06F 1/1683; G06F 1/1632; G06F 1/1635; G06F 1/1607

(57) ABSTRACT

A digital wall calendar apparatus for digital schedule tracking includes a housing having a front side, a back side, a left side, a right side, a top side, and a bottom side. The housing is rectangular and the back side has a plurality of mounting apertures to receive wall-mounted hardware to hang the housing vertically against a wall. A display is coupled to the front side of the housing. The display is a touchscreen. A microprocessor is coupled within the housing and is in operational communication with the display. A transceiver is coupled within the housing and is in operational communication with the microprocessor. A battery is coupled within the housing and is in operational communication with the microprocessor. A charging port is coupled to the housing and is in operational communication with the battery.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to calendar devices and more particularly pertains to a new calendar device for digital schedule tracking.

### (2) Description of Related Art Including Information Disclosed Under 37 CFR 1.97 and 1.98

The prior art relates to calendar devices. Known devices often have a fixed interface rather than a display capable of completely changing to view by day, month, or year. Such known devices also lack a digital keyboard and a stylus to control the touch screen. Known devices also lack multiple mounting options for vertical mounting both with or without hardware.

### BRIEF SUMMARY OF THE INVENTION

An embodiment of the disclosure meets the needs presented above by generally comprising a housing having a front side, a back side, a left side, a right side, a top side, and a bottom side. The housing is rectangular and the back side has a plurality of mounting apertures configured to receive wall-mounted hardware to hang the housing vertically against a wall. A display is coupled to the front side of the housing. The display is a touchscreen. A microprocessor is coupled within the housing and is in operational communication with the display. A transceiver is coupled within the housing and is in operational communication with the microprocessor. A battery is coupled within the housing and is in operational communication with the microprocessor. A charging port is coupled to the housing and is in operational communication with the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a digital wall calendar apparatus according to an embodiment of the disclosure.

FIG. 2 is an isometric view of an embodiment of the disclosure.

FIG. 3 is a front elevation view of an embodiment of the disclosure.

FIG. 4 is a front elevation view of an embodiment of the disclosure.

FIG. 5 is a block diagram of an embodiment of the disclosure.

### DETAILED DESCRIPTION OF THE INVENTION

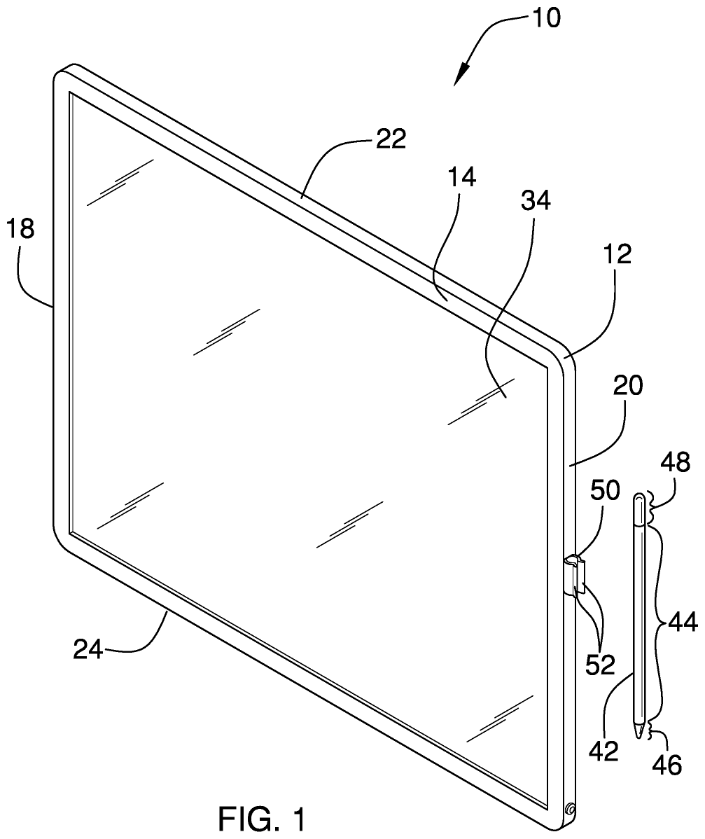

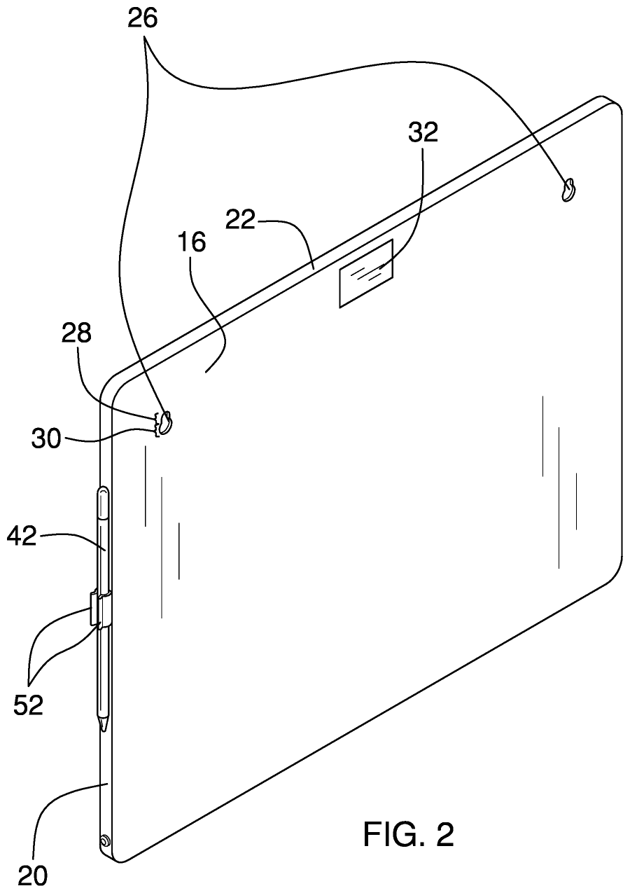

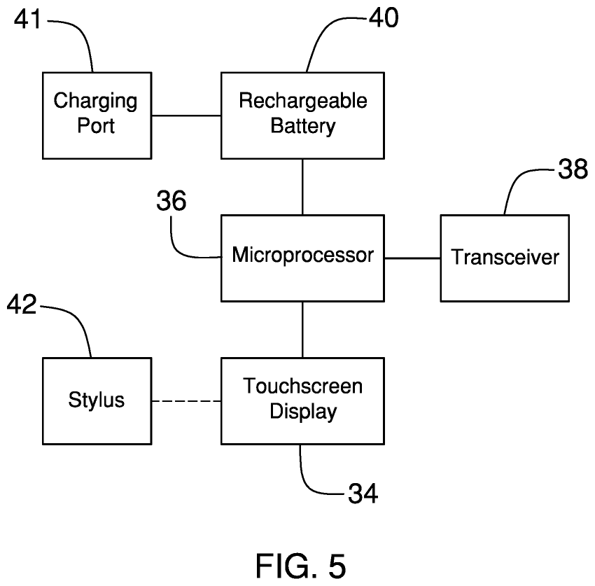

With reference now to the drawings, and in particular to FIGS. 1 through 5 thereof, a new calendar device embodying the principles and concepts of an embodiment of the disclosure and generally designated by the reference numeral 10 will be described.

As best illustrated in FIGS. 1 through 5, the digital wall calendar apparatus 10 generally comprises a housing 12 having a front side 14, a back side 16, a left side 18, a right side 20, a top side 22, and a bottom side 24. The housing 12 is rectangular. The back side 16 has a plurality of mounting apertures 26 configured to receive wall-mounted hardware to hang the housing 12 vertically against a wall. The plurality of mounting apertures 26 may be a pair of mounting apertures 26 extending through the back side 16 of the housing proximal the top side 22. Each mounting aperture 26 may have an upper catch portion 28 extending from a round lower receive portion 30.

A magnet 32 is coupled to the housing 12. The magnet 32 may be medially coupled to the back side 16 of the housing 12 proximal the top side 22. The magnet 32 may be sufficiently powerful to secure the apparatus 10 to a vertical ferrous surface such as, but not limited to, a refrigerator or a metal wall.

A display 34 is coupled to the housing 12. The display 34 is coupled to the front side 14 of the housing and is a touchscreen. A microprocessor 36 and a transceiver 38 are coupled within the housing 12. The microprocessor 36 is in operational communication with the display 34 and the transceiver 38 is in operational communication with the microprocessor 36. The transceiver 38 allows the apparatus 10 to communicate with a personal electronic device or directly with the internet. A battery 40 is coupled within the housing 12 and is in operational communication with the microprocessor 36. A charging port 41 is coupled to the housing 12 and is in operational communication with the battery 40.

A stylus 42 is in wireless communication with the transceiver 38 and in operational communication with the display 34. The stylus 42 may have a shaft portion 44, a conical tip portion 46, and a rounded top portion 48. A stylus clip 50 is coupled to the housing 12. The stylus clip 50 may be coupled to the right side 20 of the housing and selectively receives the shaft portion 44 of the stylus. The stylus clip 50 may include a pair of opposing S-shaped clip halves 52. Each clip half 52 is sufficiently elastically deformable so as to receive and secure the stylus 42 as well as to allow the user to pull the stylus 42 from the stylus clip 50.

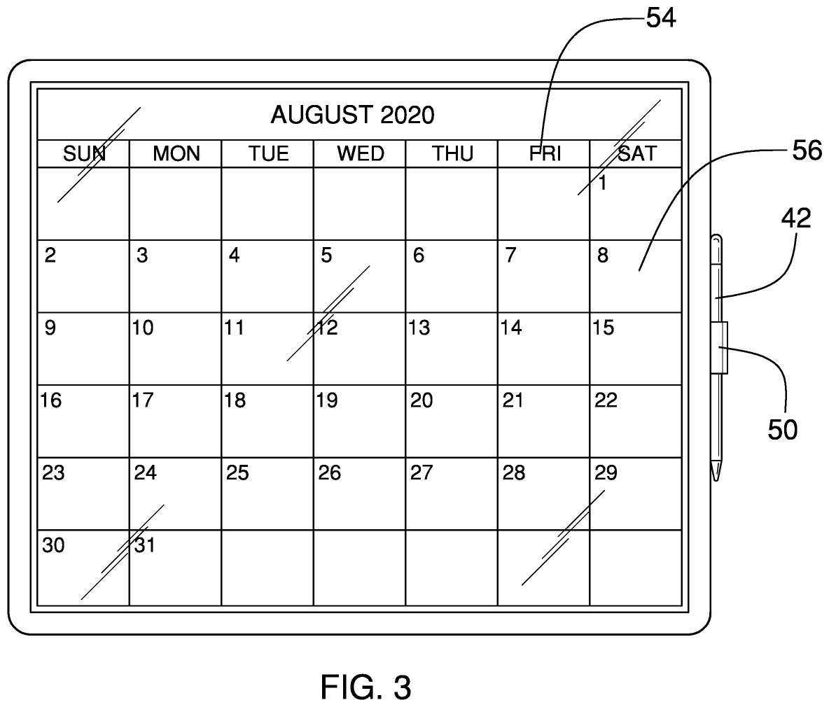

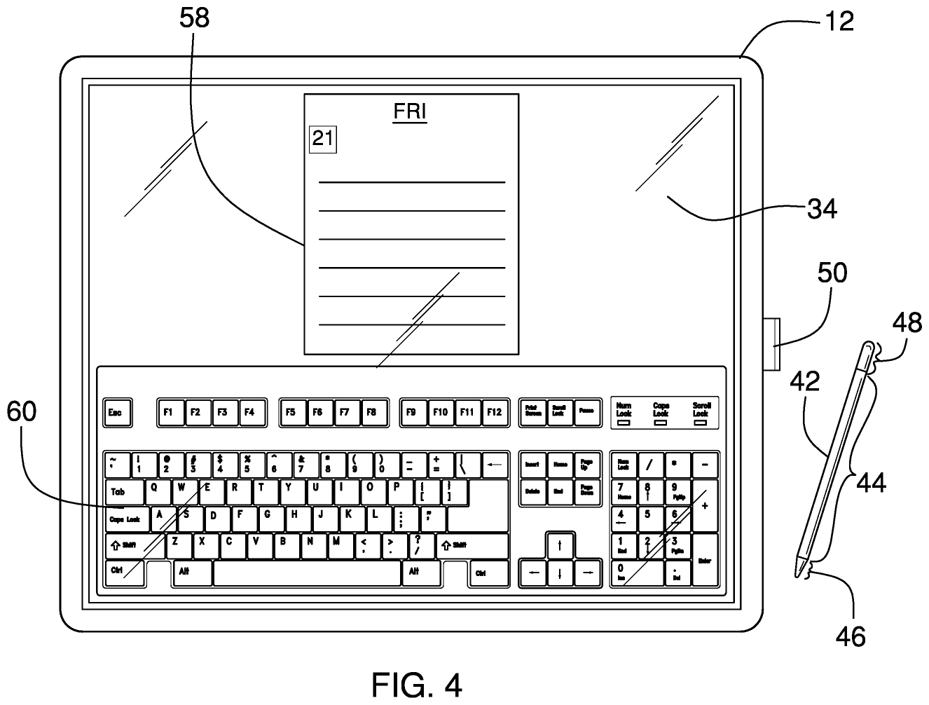

In use, the housing 12 is mounted to a vertical surface using either the pair of mounting apertures 26 or the magnet 32. The user may then view a digital calendar 54 on the display 34 in a month view 56 as shown in FIG. 3 or in a day view 58 as shown in FIG. 4. In the day view 58 there may be a digital keyboard 60 for the user to add typed events in addition to writing with the stylus 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A digital wall calendar apparatus comprising:
a housing having a front side, a back side, a left side, a right side, a top side, and a bottom side, the housing being rectangular, the back side having a plurality of mounting apertures configured to receive wall-mounted hardware to hang the housing vertically against a wall;
a display coupled to the housing, the display being coupled to the front side of the housing, the display being a touchscreen;
a microprocessor coupled within the housing, the microprocessor being in operational communication with the display;
a transceiver coupled within the housing, the transceiver being in operational communication with the microprocessor;
a battery coupled within the housing, the battery being in operational communication with the microprocessor;
a charging port coupled to the housing, the charging port being in operational communication with the battery;
a stylus, the stylus being in wireless communication with the transceiver and in operational communication with the display; and
a stylus clip coupled to the housing, the stylus clip being coupled to the right side of the housing and selectively receiving a shaft portion of the stylus such that the shaft portion of the stylus is abutting the housing when the stylus is engaged to the stylus clip, the stylus clip including a pair of opposing S-shaped clip halves, each clip half being sufficiently elastically deformable so as to receive and secure the stylus as well as to allow the user to pull the stylus from the stylus clip.

2. (canceled)

3. (canceled)

4. (canceled)

5. The digital wall calendar apparatus of claim 1 further comprising a magnet coupled to the housing, the magnet being medially coupled to the back side of the housing proximal the top side, the magnet being sufficiently powerful to secure the apparatus to a vertical ferrous surface such as, but not limited to, a refrigerator or a metal wall.

6. The digital wall calendar apparatus of claim 1 further comprising the plurality of mounting apertures being a pair of mounting apertures extending through the back side of the housing proximal the top side, each mounting aperture having an upper catch portion extending from a round lower receive portion.

7. A digital wall calendar apparatus comprising:
a housing having a front side, a back side, a left side, a right side, a top side, and a bottom side, the housing being rectangular, the back side having a plurality of mounting apertures configured to receive wall-mounted hardware to hang the housing vertically against a wall, the plurality of mounting apertures being a pair of mounting apertures extending through the back side of the housing proximal the top side, each mounting aperture having an upper catch portion extending from a round lower receive portion;
a magnet coupled to the housing, the magnet being medially coupled to the back side of the housing proximal the top side, the magnet being sufficiently powerful to secure the apparatus to a vertical ferrous surface such as, but not limited to, a refrigerator or a metal wall;
a display coupled to the housing, the display being coupled to the front side of the housing, the display being a touchscreen;
a microprocessor coupled within the housing, the microprocessor being in operational communication with the display;
a transceiver coupled within the housing, the transceiver being in operational communication with the microprocessor;
a stylus, the stylus being in wireless communication with the transceiver and in operational communication with the display;
a battery coupled within the housing, the battery being in operational communication with the microprocessor;
a stylus clip coupled to the housing, the stylus clip being coupled to the right side of the housing and selectively receiving a shaft portion of the stylus such that the shaft portion of the stylus is abutting the housing when the stylus is engaged to the stylus clip, the stylus clip including a pair of opposing S-shaped clip halves, each clip half being sufficiently elastically deformable so as to receive and secure the stylus as well as to allow the user to pull the stylus from the stylus clip; and
a charging port coupled to the housing, the charging port being in operational communication with the battery.
